(19) United States
(12) Patent Application Publication
(10) Pub. No.: US 2026/0249629 A1
(43) Pub. Date: Aug. 27, 2026

(54) PRINTING APPARATUS

(71) Applicant: SEIKO EPSON CORPORATION, Tokyo (JP)

(72) Inventors: Irwan SAPUTRA, Bekasi Regency (ID); Faridhul IKHSAN, Kabupaten Bekasi (ID); Muhamad AUF, Bekasi (ID); Hikaru KUMAGAI, Matsumoto (JP)

(21) Appl. No.: 19/547,759

(22) Filed: Feb. 24, 2026

(30) Foreign Application Priority Data
Feb. 26, 2025 (JP) 2025-029058

(51) Int. Cl. B41J 29/377; A62C 3/16; B41J 2/045; B41J 29/02; B41J 29/393

(52) U.S. Cl. CPC B41J 29/377; A62C 3/16; B41J 2/04581; B41J 29/02; B41J 29/393

(57) ABSTRACT

A printing apparatus includes a substrate including a first element that is supplied with power of 100 W or more and a second element that is supplied with power of less than 100 W, in which the first element is covered with a fireproof enclosure, the second element is not covered with the fireproof enclosure, the fireproof enclosure includes a wall portion and a top plate portion, the wall portion is a flame-retardant resin member having a V-1 grade or higher and surrounds four sides of the first element, a first surface of the wall portion is in contact with the substrate, a second surface opposite to the first surface of the wall portion is in contact with the top plate portion, and the top plate portion is made of aluminum and unevenness for heat dissipation is arranged on the top plate portion.

### CROSS REFERENCE TO RELATED APPLICATIONS

The present application is based on, and claims priority from JP Application Serial Number 2025-029058, filed February 26, 2025, the disclosure of which is hereby incorporated by reference herein in its entirety.

### BACKGROUND

### Technical Field

The present disclosure relates to a printing apparatus.

### Related Art

In recent years, various electric appliances are used, and electric appliances continue to evolve technically for the improvement of the quality of human life. With the progress of technology, electric appliances equipped with new technology are created, and in order to ensure that electric appliances equipped with new technologies do not threaten human safety, safety standards are established worldwide. For example, as an international safety standard, IEC 62368-1, which is a safety standard for information and communication equipment, is defined. Along with the progress of technology, IEC 62368-1 is also updated, and the fourth edition of IEC 62368-1 is established in 2023. IEC 62368-1 is also related to a fireproof enclosure provided for preventing fire spread when an electronic component becomes highly heated and ignites, as described in JP-A-2004-103907. In addition, as described in JP-A-2014-059346, in image forming apparatuses, disclosures considering fireproof enclosures are made.

However, there are few disclosures related to a fireproof enclosure for an image forming apparatus or a printing apparatus. Further, since electronic components that become highly heated are covered, the inside of the enclosure tends to become highly heated, and the electronic components in the fireproof enclosure also tend to become highly heated and are likely to ignite. Therefore, there is room for improvement in a method of dissipating heat in an enclosure while preventing the spread of fire in the printing apparatus.

### SUMMARY

According to an aspect of the present disclosure, there is provided a printing apparatus including a transport section configured to transport a medium, a discharge section configured to discharge a liquid to the medium, and a substrate including a first element that is supplied with power of 100 W or more and a second element that is supplied with power of less than 100 W, in which the first element is covered with a fireproof enclosure, the second element is not covered with the fireproof enclosure, the fireproof enclosure includes a wall portion and a top plate portion, the wall portion is a flame-retardant resin member having a V-1 grade or higher and surrounds four sides of the first element, a first surface of the wall portion is in contact with the substrate, a second surface opposite to the first surface of the wall portion is in contact with the top plate portion, and the top plate portion is made of aluminum and unevenness for heat dissipation is arranged on the top plate portion.

### BRIEF DESCRIPTION OF THE DRAWINGS

FIG. 1 is a diagram showing a schematic configuration of a printing apparatus.

FIG. 2 is a diagram showing a functional configuration of the printing apparatus.

FIG. 3 is a diagram showing a circuit configuration of a power supply circuit.

FIG. 4 is a diagram showing a circuit configuration of a drive circuit.

FIG. 5 is a diagram for explaining a schematic configuration of a discharge section.

FIG. 6 is a diagram showing an example of a signal waveform of a drive signal.

FIG. 7 is a diagram showing an example of a relationship between a size of a dot formed at a medium and a signal waveform of a drive voltage.

FIG. 8 is a diagram showing an example of a functional configuration of a drive signal selection circuit.

FIG. 9 is a table showing an example of decoding contents of a decoder included in a selection control circuit.

FIG. 10 is a diagram showing an example of a configuration of a selection circuit corresponding to the discharge section.

FIG. 11 is a diagram for explaining a specific example of a latch signal, a change signal, a clock signal, and a print data signal.

FIG. 12 is a perspective view of a substrate provided with a fireproof enclosure.

FIG. 13 is a side view of a substrate in a state where the fireproof enclosure shown in FIG. 12 is cut.

FIG. 14 is a view of a wall portion viewed from a distal end side of an arrow indicating a direction of a Z axis.

### DESCRIPTION OF EMBODIMENTS

Hereinafter, preferred embodiments of the present disclosure will be described with reference to the drawings. The drawings to be used are for convenience of description. Embodiments to be described below do not inappropriately limit the contents of the present disclosure described in the claims. In addition, not all of configurations to be described below are necessarily essential requirements of the present disclosure.

In the following description, an ink jet printer is exemplified as an example of a printing apparatus according to the present disclosure.

### Overview of Printing Apparatus

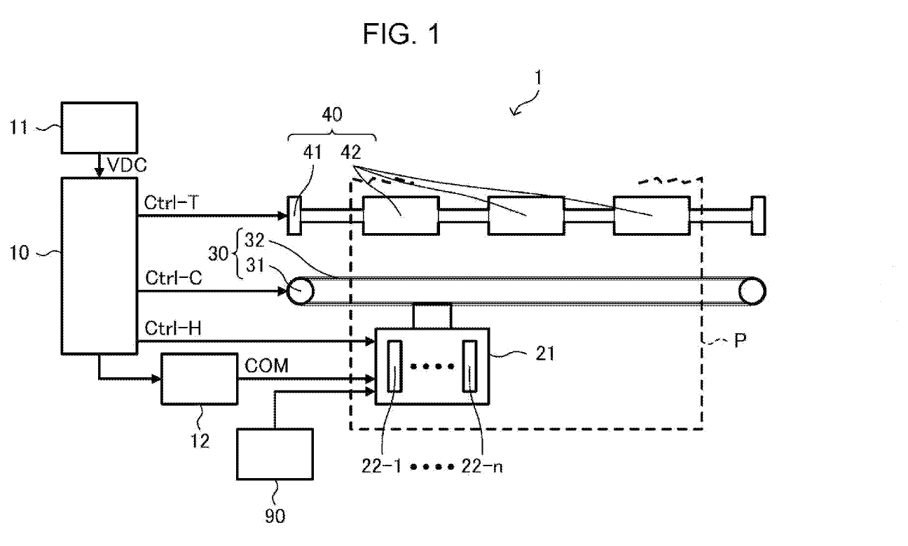

FIG. 1 is a diagram showing an example of a schematic configuration of a printing apparatus 1. The printing apparatus 1 of the present embodiment is a so-called serial printing type ink jet printer in which a carriage 21 on which print heads 22-1 to 22-n are mounted reciprocates along a scanning axis, and the print heads 22-1 to 22-n discharge ink, as an example of a liquid, onto a medium P transported along a transport direction, thereby forming a desired image at the medium P. As the medium P used in the printing apparatus 1, in addition to printing paper such as plain paper, any printing medium such as a resin film or a fabric can be used. In addition, the medium P may have a size equal to or smaller than an A3 short side width.

As shown in FIG. 1, the printing apparatus 1 includes a control circuit substrate 10, a power supply circuit substrate 11, a drive circuit substrate 12, the print heads 22-1 to 22-n, a movement unit 30, a transport unit 40, and an ink container 90.

The ink container 90 stores a plurality of types of ink to be discharged to the medium P. As such an ink container 90, an ink cartridge, a bag-shaped ink pack formed of a flexible film, an ink tank that can be replenished with ink, or the like can be used.

The control circuit substrate 10 is mounted with a control circuit including a processing circuit such as a central processing unit (CPU) and a field programmable gate array (FPGA), a storage circuit such as a semiconductor memory. The control circuit controls each element of the printing apparatus 1 and controls the discharge of the ink from discharge sections 600[1] to 600[p], which will be described later.

A power supply circuit is mounted on the power supply circuit substrate 11. For example, the power supply circuit generates a power supply voltage VDC, which is a constant DC voltage with a voltage value of, for example, 48 V from an AC voltage signal such as a commercial power supply supplied to the printing apparatus 1, and outputs the power supply voltage VDC to each section of the printing apparatus 1. For example, the power supply circuit may include an AC/DC converter such as a flyback circuit, and may further include a DC/DC converter.

A drive circuit that generates a drive signal COM based on data supplied from the control circuit is mounted on the drive circuit substrate 12. The drive signal COM is a signal for discharging ink to the discharge sections 600[1] to 600[p] which will be described later.

The print heads 22-1 to 22-n are mounted on the carriage 21. Control signals Ctrl-H are supplied from the control circuit substrate 10 to the print heads 22-1 to 22-n, and the drive signal COM is supplied from the drive circuit substrate 12 to the print heads 22-1 to 22-n. Further, the ink stored in the ink container 90 is supplied to the print heads 22-1 to 22-n via a tube (not shown) or the like. Each of the print heads 22-1 to 22-n discharges the supplied ink onto the medium P, based on the control signal Ctrl-H and the drive signal COM.

The movement unit 30 includes a carriage motor 31 and an endless belt 32. The carriage motor 31 operates based on a control signal Ctrl-C supplied from the control circuit substrate 10. The carriage 21 on which the print heads 22-1 to 22-n are mounted is fixed to the endless belt 32. Further, the endless belt 32 rotates in accordance with an operation of the carriage motor 31. Then, the carriage 21 fixed to the endless belt 32 moves along a scanning direction by the rotation of the endless belt 32. That is, the movement unit 30 controls the movement of the print heads 22-1 to 22-n mounted on the carriage 21.

The transport unit 40 includes a transport motor 41 and transport rollers 42. The transport motor 41 operates based on a control signal Ctrl-T supplied from the control circuit substrate 10. The transport rollers 42 rotate in accordance with an operation of the transport motor 41 in a state of pinching the medium P. By rotation of the transport rollers 42, the medium P pinched by the transport rollers 42 is transported along the transport direction. That is, the transport unit 40 transports the medium P.

In the printing apparatus 1 configured as described above, the movement unit 30 controls the reciprocating motion of the carriage 21 along the scanning direction, and the transport unit 40 controls the transport of the medium P along the transport direction. Then, each of the print heads 22-1 to 22-n mounted on the carriage 21 discharges the ink to the medium P in conjunction with the reciprocating motion of the carriage 21 and the transport of the medium P. Accordingly, the ink discharged from each of the print heads 22-1 to 22-n lands on any surface of the medium P, and a desired image is formed at the medium P.

### 2. Functional Configuration of Printing Apparatus

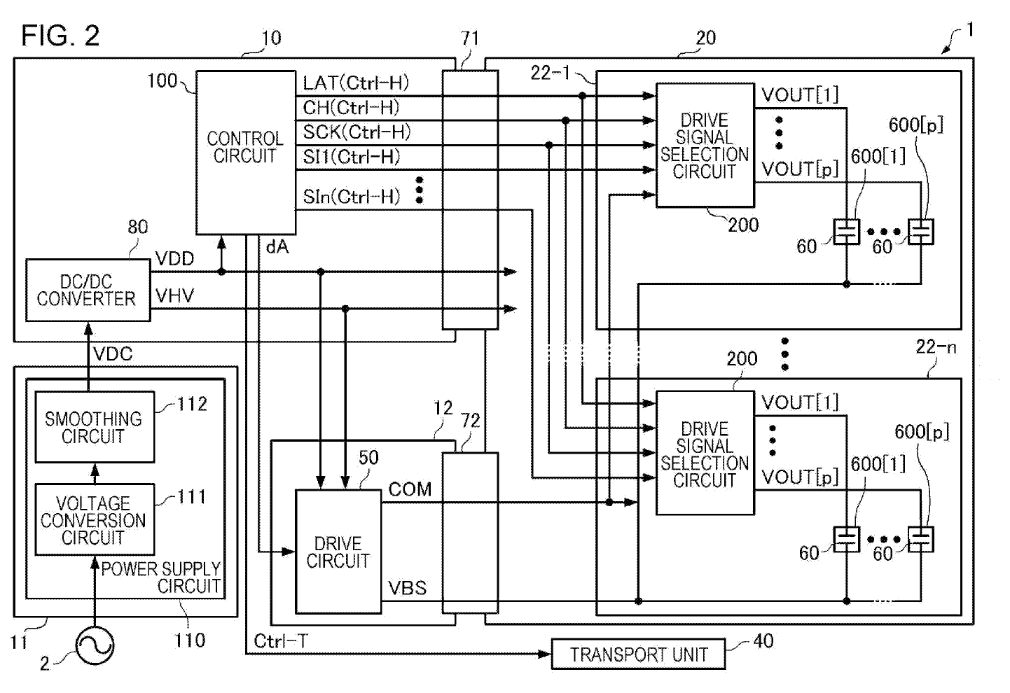

Next, a functional configuration of the printing apparatus 1 will be described. FIG. 2 is a diagram showing a functional configuration of the printing apparatus 1. As shown in FIG. 2, the printing apparatus 1 includes the control circuit substrate 10, the power supply circuit substrate 11, the drive circuit substrate 12, a head unit 20, and the transport unit 40.

The control circuit substrate 10 and the head unit 20 are coupled to each other via a cable 71. The drive circuit substrate 12 and the head unit 20 are coupled to each other via a cable 72. The cables 71 and 72 are a sliding cable that can follow the movement of the carriage 21, and may be, for example, a flexible flat cable (FFC).

A power supply circuit 110 is mounted on the power supply circuit substrate 11. The power supply circuit 110 includes a voltage conversion circuit 111 and a smoothing circuit 112. The voltage conversion circuit 111 transforms a signal of an AC voltage such as a commercial power supply and outputs the transformed AC voltage to the smoothing circuit 112. The smoothing circuit 112 smooths the AC voltage output from the voltage conversion circuit 111 to output the power supply voltage VDC of the DC voltage.

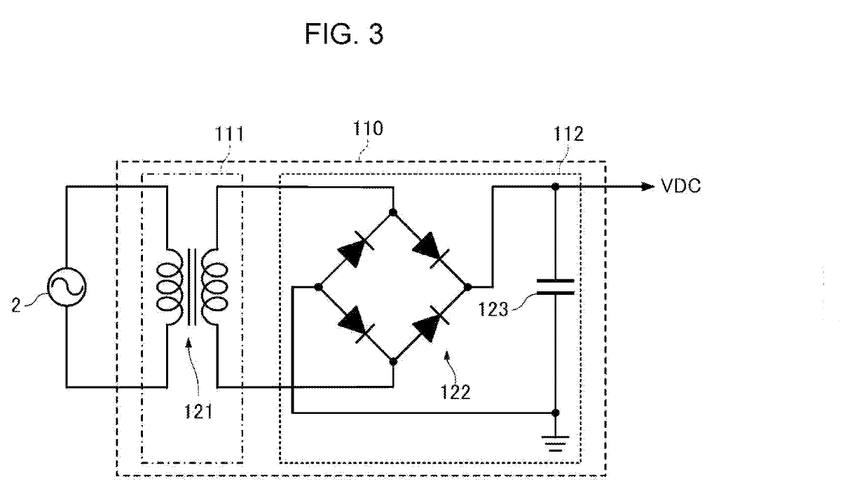

FIG. 3 is a circuit diagram showing a schematic configuration of the voltage conversion circuit 111 and the smoothing circuit 112. As shown in FIG. 3, the voltage conversion circuit 111 includes a transformer 121. For example, the transformer 121 transforms the AC voltage of the 100 V commercial power supply 2 and outputs the transformed AC voltage to the smoothing circuit 112. As shown in FIG. 3, the smoothing circuit 112 includes a rectifying circuit 122 and a capacitor 123. The rectifying circuit 122 is, for example, a diode bridge circuit including a plurality of diodes, and rectifies the AC voltage converted by the voltage conversion circuit 111. The capacitor 123 is a smoothing capacitor that smooths a voltage rectified by the rectifying circuit 122, converts the voltage into a DC voltage of, for example, 48 V, and outputs the power supply voltage VDC of the DC voltage.

Returning to the description of FIG. 2, a DC/DC converter 80 and a control circuit 100 are mounted on the control circuit substrate 10.

The DC/DC converter 80 steps down the power supply voltage VDC output from the smoothing circuit 112 of the power supply circuit 110, generates a power supply voltage VDD, which is a constant DC voltage with a voltage value of, for example, 3.3 V, and outputs the power supply voltage VDD to the control circuit 100 and the drive circuit 50 and outputs the power supply voltage VDD to the head unit 20 via the cable 71. The DC/DC converter 80 steps down the power supply voltage VDC to generate a power supply voltage VHV, which is a constant DC voltage with a voltage value of, for example, 42 V, and outputs a power supply voltage VHV to the drive circuit 50 and the head unit 20 via the cable 71.

The control circuit 100 includes, for example, a processor such as a microcontroller, and is communicably connected to an external device such as a host computer (not shown) provided outside the printing apparatus 1. An image information signal including image data formed at the medium P from the external device is input to the control circuit 100. The control circuit 100 performs predetermined image processing on the input image information signal to generate various data for controlling the printing apparatus 1 and a signal corresponding to the data.

The control circuit 100 generates the control signal Ctrl-T for controlling the transport of the medium P and outputs the control signal Ctrl-T to the transport unit 40. Accordingly, the transport motor 41 included in the transport unit 40 is rotationally driven, and the transport in the transport direction of the medium P is controlled. Here, the control signal Ctrl-T output by the control circuit 100 may be input to the transport motor 41 after being signal-converted in a not shown driver circuit.

In addition, the control circuit 100 generates a latch signal LAT, a change signal CH, a clock signal SCK, and print data signals SI1 to SIn, as the control signal Ctrl-H for controlling the head unit 20, based on the input image information signal, and outputs the latch signal LAT, the change signal CH, the clock signal SCK, and the print data signals SI1 to SIn to the head unit 20 via the cable 71. The details of the latch signal LAT, the change signal CH, the clock signal SCK, and the print data signals SI1 to SIn will be described later.

The drive circuit 50 is mounted on the drive circuit substrate 12. The control circuit 100 outputs a base drive signal dA, which is a digital signal, to the drive circuit 50. The drive circuit substrate 12 may be mounted on the head unit 20.

The drive circuit 50 generates a drive signal COM including one or a plurality of signal waveforms by performing digital/analog signal conversion on the base drive signal dA of the input digital signal and then performing class D amplification on the converted analog signal. The drive circuit 50 may generate a plurality of drive signals COM. The drive circuit 50 outputs the generated drive signal COM to the head unit 20 via a cable 72. Here, the base drive signal dA is a digital signal for defining the signal waveform of the drive signal COM, and the drive circuit 50 generates a drive signal COM, which is an analog signal, by performing class D amplification on the signal waveform defined by the base drive signal dA. That is, the base drive signal dA is a digital signal serving as a base of the drive signal COM output from the drive circuit 50. However, the base drive signal dA may be an analog signal as long as the signal waveform of the drive signal COM can be defined. Further, the drive circuit 50 may amplify the signal waveform defined by the base drive signal dA and output the amplified signal waveform as the drive signal COM. Therefore, the drive circuit 50 may generate the drive signal COM by performing class A amplification, class B amplification, or class AB amplification on the signal waveform that is defined by the base drive signal dA.

In addition, the drive circuit 50 generates a reference voltage VBS serving as a reference potential for driving a piezoelectric element 60, which will be described later, included in the head unit 20. The drive circuit 50 outputs the generated reference voltage VBS to the head unit 20 via the cable 72. Such a reference voltage VBS may be, for example, a ground potential having a voltage value of 0 V, or may be a DC voltage having a voltage value of 5.5 V, 6 V, or the like.

The head unit 20 includes the print heads 22-1 to 22-n. In addition, a print head 22-i includes a drive signal selection circuit 200 and p discharge sections 600[1] to 600[p]. i is each integer of 1 or more and n or less.

The drive signal selection circuit 200 includes one or a plurality of integrated circuit devices. The latch signal LAT, the change signal CH, the clock signal SCK, a print data signal SIi, and the drive signal COM are input to the drive signal selection circuit 200. The drive signal selection circuit 200 generates and outputs drive voltages VOUT[1] to VOUT[p] that individually correspond to each of the discharge sections 600[1] to 600[p] by selecting or not selecting a signal waveform of the drive signal COM, based on the input latch signal LAT, the change signal CH, the clock signal SCK, and the print data signal SIi. That is, the drive signal selection circuit 200 functions as a drive control section that controls application of the drive signal COM to the discharge sections 600[1] to 600[p]. The configuration and operation details of the drive signal selection circuit 200 will be described later.

Each of the discharge sections 600[1] to 600[p] includes the piezoelectric element 60. A drive voltage VOUT[j] output by the drive signal selection circuit 200 is supplied to one end of the piezoelectric element 60 included in a discharge section 600[j]. j is each integer of 1 or more and p or less. In addition, the reference voltage VBS is commonly supplied to the other ends of the p piezoelectric elements 60 included in the discharge sections 600[1] to 600[p]. The piezoelectric element 60 included in the discharge section 600[j] is displaced by a potential difference between the drive voltage VOUT[j] and the reference voltage VBS. An amount of ink corresponding to the displacement of the piezoelectric element 60 is discharged from the corresponding discharge section 600[j]. Since the drive voltage VOUT[j] is generated by selecting or not selecting the signal waveform of the drive signal COM, in other words, the discharge section 600[j] discharges ink when the drive signal COM is applied. Then, the ink discharged from the discharge sections 600[1] to 600[p] included in each of the print heads 22-1 to 22-n lands on the medium P, and thus an image is formed at the medium P.

As described above, the discharge section 600[j] included in the print head 22-i applies the drive voltage VOUT[j] that is generated based on the latch signal LAT, the change signal CH, the clock signal SCK, and the print data signal SIi, to discharge the ink to the medium P. In other words, the latch signal LAT, the change signal CH, the clock signal SCK, and the print data signals SI1 to SIn are discharge control signals that control the discharge of the ink to the medium P of the discharge section 600[j], respectively, and the discharge section 600[j] discharges the ink to the medium P based on the discharge control signals.

Here, the print heads 22-1 to 22-n all have the same configuration, and may be referred to as a print head 22 when it is not necessary to distinguish the print heads. At this time, an explanation will be given on an assumption that a print data signal SI, as print data signals SI1 to SIn, is input to the print head 22. In addition, the discharge sections 600[1] to 600[p] included in the print head 22 all have the same configuration, and may be simply referred to as a discharge section 600 when it is not necessary to distinguish the discharge sections. At this time, an explanation will be given on an assumption that a drive voltage VOUT, as the drive voltages VOUT[1] to VOUT[p], is supplied to the discharge section 600.

### 3. Configuration of Drive Circuit

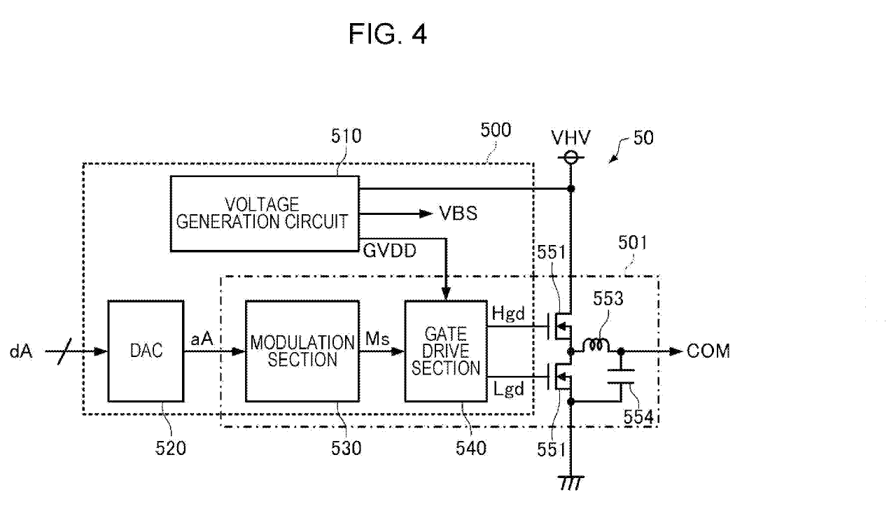

FIG. 4 is a diagram showing a circuit configuration of the drive circuit 50. As shown in FIG. 4, the drive circuit 50 includes an integrated circuit 500, transistors 551 and 552, a coil 553, and a capacitor 554. The integrated circuit 500 includes a voltage generation circuit 510, a DAC 520, a modulation section 530, and a gate drive section 540. DAC is an abbreviation for a digital to analog converter.

The voltage generation circuit 510 generates a voltage GVDD based on the power supply voltage VHV. The voltage GVDD is a DC voltage having a voltage value of, for example, 7.5 V, and is input to the gate drive section 540. In addition, the voltage generation circuit 510 generates a reference voltage VBS based on the power supply voltage VHV.

The base drive signal dA is input to the DAC 520. The DAC 520 converts the input base drive signal dA into an analog base drive signal aA. The base drive signal aA is a target signal before amplification of the drive signal COM. The base drive signal aA is input to the modulation section 530. The modulation section 530 outputs a modulated signal Ms obtained by performing pulse width modulation on the base drive signal aA. The voltages VHV and GVDD and the modulated signal Ms are input to the gate drive section 540. The gate drive section 540 amplifies the input modulated signal Ms based on the voltage GVDD and inverts logic levels of an amplification control signal Hgd, which is level-shifted to a high amplitude logic level based on the voltage VHV, and the input modulated signal Ms, to generate an amplification control signal Lgd based on the voltage GVDD. That is, the amplification control signal Hgd and the amplification control signal Lgd are set to H level exclusively with each other.

The voltage VHV is supplied to a drain terminal of the transistor 551. The amplification control signal Hgd is supplied to a gate terminal of the transistor 551. A source terminal of the transistor 551 is electrically coupled to the drain terminal of the transistor 552. Further, the amplification control signal Lgd is supplied to a gate terminal of the transistor 552. A source terminal of the transistor 552 is coupled to the ground. The transistor 551 coupled as described above operates in accordance with the amplification control signal Hgd, and the transistor 552 operates in accordance with the amplification control signal Lgd. That is, the transistor 551 and the transistor 552 are turned on exclusively with each other. Accordingly, at a coupling point between the source terminal of the transistor 551 and the drain terminal of the transistor 552, an amplified modulation signal obtained by amplifying the modulated signal Ms based on the voltage VHV is generated. For example, each of the transistors 551 and 552 is an N-channel type FET. FET is an abbreviation for a field effect transistor.

One end of the coil 553 is commonly coupled to the source terminal of the transistor 551 and the drain terminal of the transistor 552. In addition, the other end of the coil 553 is coupled to one end of the capacitor 554. The other end of the capacitor 554 is coupled to the ground. That is, the coil 553 and the capacitor 554 constitute a low-pass filter. Then, the amplified modulation signal is supplied to the low-pass filter, so that the amplified modulation signal is demodulated, and the drive signal COM is generated. The drive circuit 50 outputs the drive signal COM generated as described above.

As described above, the drive circuit 50 generates the drive signal COM by performing class D amplification after the base drive signal dA is subjected to digital/analog conversion. That is, the DAC 520, the modulation section 530, the gate drive section 540, the transistors 551 and 552, the coil 553, and the capacitor 554 configure an amplifier circuit 501, and the amplifier circuit 501 is a class D amplifier. However, the drive circuit 50 may generate the drive signal COM by performing class A amplification, class B amplification, or class AB amplification on the signal waveform that is defined by the base drive signal dA.

### 4. Structure of Discharge Section

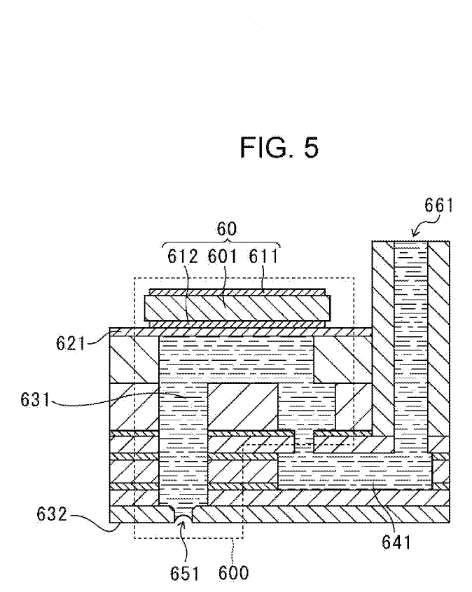

Next, the structure of the discharge section 600 will be described. FIG. 5 is a diagram for explaining a schematic configuration of the discharge section 600. In addition to the discharge section 600, FIG. 5 shows a nozzle plate 632, a reservoir 641, and a supply port 661.

As shown in FIG. 5, the discharge section 600 includes the piezoelectric element 60, a vibrating plate 621, a cavity 631, and a nozzle 651. Further, the piezoelectric element 60 includes a piezoelectric body 601 and electrodes 611 and 612. The piezoelectric element 60 is configured by positioning the electrodes 611 and 612 so as to pinch the piezoelectric body 601. Such a piezoelectric element 60 is driven such that a center portion is displaced in an up-down direction according to a potential difference between a voltage supplied to the electrode 611 and a voltage supplied to the electrode 612. Specifically, the drive voltage VOUT based on the drive signal COM is supplied to the electrode 611, and the reference voltage VBS is supplied to the electrode 612. When the voltage value of the drive voltage VOUT supplied to the electrode 611 changes, a potential difference between the drive voltage VOUT supplied to the electrode 611 and the reference voltage VBS supplied to the electrode 612 changes. As a result, the piezoelectric element 60 is driven such that the center portion is displaced in the up-down direction.

The vibrating plate 621 is positioned below the piezoelectric element 60 in FIG. 5. In other words, the piezoelectric element 60 is formed at an upper surface of the vibrating plate 621 in FIG. 5. Such a vibrating plate 621 is displaced in the up-down direction as the piezoelectric element 60 is driven in the up-down direction.

The cavity 631 is positioned below the vibrating plate 621 in FIG. 5. Ink is supplied to the cavity 631 from the reservoir 641. Further, the ink stored in the ink container 90 is introduced into the reservoir 641 via the supply port 661. That is, an inside of the cavity 631 is filled with the ink stored in the ink container 90. An internal volume of the cavity 631 expands or is reduced as the vibrating plate 621 is displaced in the up-down direction. That is, the vibrating plate 621 functions as a diaphragm that changes the internal volume of the cavity 631, and the cavity 631 functions as a pressure chamber in which the pressure changes as the vibrating plate 621 is displaced in the up-down direction.

The nozzle 651 is an opening portion provided on the nozzle plate 632 and communicates with the cavity 631. When the internal volume of the cavity 631 changes, the ink filled in the cavity 631 is discharged from the nozzle 651 according to the change in the internal volume.

In the discharge section 600 configured as described above, when the piezoelectric element 60 is driven to deflect in an upward direction, the vibrating plate 621 is displaced in the upward direction. Accordingly, the internal volume of the cavity 631 expands, and as a result, the ink stored in the reservoir 641 is drawn into the cavity 631. On the other hand, when the piezoelectric element 60 is driven to deflect in a downward direction, the vibrating plate 621 is displaced in the downward direction. Accordingly, the internal volume of the cavity 631 is reduced, and as a result, an amount of ink corresponding to a degree of reduction of the internal volume of the cavity 631 is discharged from the nozzle 651.

The piezoelectric element 60 may have a structure as long as the piezoelectric element 60 is driven by being supplied with the drive voltage VOUT corresponding to the drive signal COM and ink can be discharged from the nozzle 651 by driving, and the structure is not limited to that shown in FIG. 5.

### 5. Functional Configuration of Drive Signal Selection Circuit

Next, the configuration and operation of the drive signal selection circuit 200 will be described. In describing the configuration and operation of the drive signal selection circuit 200, an example of the signal waveform of the drive signal COM input to the drive signal selection circuit 200, and an example of the signal waveform of the drive voltage VOUT output from the drive signal selection circuit 200 are described.

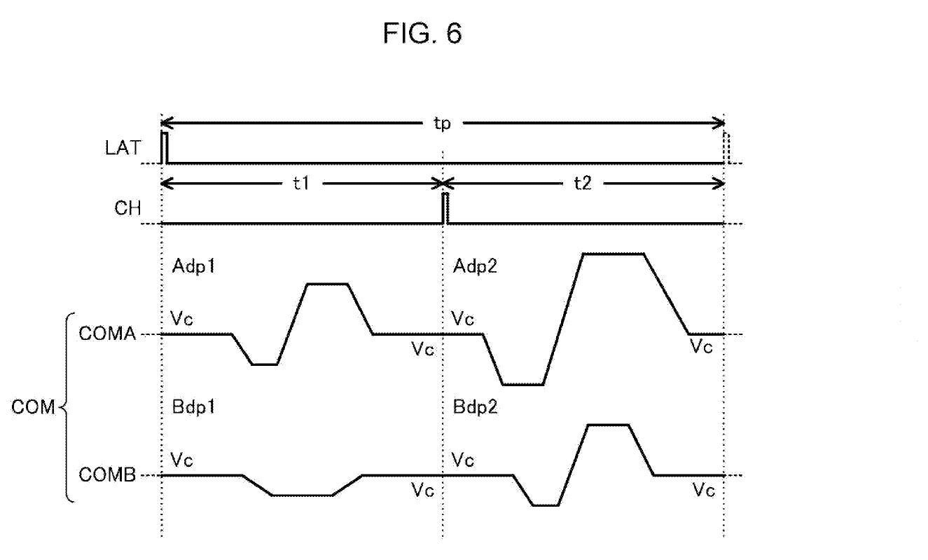

FIG. 6 is a diagram showing an example of a signal waveform of the drive signal COM. In FIG. 6, a drive signal COMA and a drive signal COMB are exemplified as two drive signals COM.

The drive signal COMA is a signal waveform in which a trapezoidal waveform Adp1 arranged in a period t1 from when the latch signal LAT rises to when the change signal CH rises and a trapezoidal waveform Adp2 arranged in a period t2 from when the change signal CH rises to when the latch signal LAT rises are made continuous. In addition, the trapezoidal waveform Adp1 is a signal waveform for discharging a predetermined amount of ink from the discharge section 600 when supplied to the piezoelectric element 60 included in the discharge section 600, and the trapezoidal waveform Adp2 is a signal waveform for discharging an amount of ink larger than the predetermined amount from the discharge section 600 when supplied to the piezoelectric element 60 included in the discharge section 600. Here, in the following description, when the trapezoidal waveform Adp1 is supplied to the piezoelectric element 60 included in the discharge section 600, an amount of ink discharged from the discharge section 600 may be referred to as a small amount, and when the trapezoidal waveform Adp2 is supplied to the piezoelectric element 60 included in the discharge section 600, an amount of ink discharged from the discharge section 600 may be referred to as a medium amount.

As shown in FIG. 6, the drive signal COMB has a signal waveform in which a trapezoidal waveform Bdp1 arranged in the period t1 and a trapezoidal waveform Bdp2 arranged in the period t2 are made continuous. In addition, the trapezoidal waveform Bdp1 is a signal waveform for not discharging the ink from the discharge section 600 when supplied to the piezoelectric element 60 included in the discharge section 600, and the trapezoidal waveform Bdp2 is a signal waveform for discharging a small amount of ink from the discharge section 600 when supplied to the piezoelectric element 60 included in the discharge section 600. Here, the trapezoidal waveform Bdp1 is a signal waveform for preventing an increase in ink viscosity by vibrating the ink in the vicinity of a nozzle opening portion included in the discharge section 600 to such an extent that the ink is not discharged. In the following description, when the trapezoidal waveform Bdp1 is supplied to the piezoelectric element 60 included in the discharge section 600, an operation of vibrating the ink in the vicinity of the nozzle opening portion may be referred to as micro vibration.

Here, as shown in FIG. 6, voltage values at the start timing and end timing of each of the trapezoidal waveforms Adp1, Adp2, Bdp1, and Bdp2 are all common to a voltage Vc. In other words, each of the trapezoidal waveforms Adp1, Adp2, Bdp1, and Bdp2 starts at the voltage Vc and ends at the voltage Vc. Then, a cycle tp including the period t1 and the period t2 corresponds to a printing cycle for forming new dots at the medium P.

Although FIG. 6 shows a case where the trapezoidal waveform Adp1 and the trapezoidal waveform Bdp2 are the same signal waveform, the trapezoidal waveform Adp1 and the trapezoidal waveform Bdp2 may be different signal waveforms. Further, in the case where the trapezoidal waveform Adp1 is supplied to the piezoelectric element 60 included in the discharge section 600 and in the case where the trapezoidal waveform Bdp2 is supplied to the piezoelectric element 60 included in the discharge section 600, an explanation will be given on an assumption that a small amount of ink is discharged from the discharge section 600 in both cases, but the present disclosure is not limited thereto. In other words, the signal waveforms of the drive signals COMA and COMB are not limited to the signal waveforms shown in FIG. 6, and combinations of various signal waveforms may be used depending on the nature of the ink discharged from the discharge section 600, the material of the medium P on which the discharged ink lands, and the like.

In addition, in FIG. 6, the case where the timing at which the trapezoidal waveform Adp1 and the trapezoidal waveform Adp2 included in the drive signal COMA are switched, and the timing at which the trapezoidal waveform Bdp1 and the trapezoidal waveform Bdp2 included in the drive signal COMB are switched are defined by one change signal CH is exemplified. However, the change signal CH that defines the timing at which the trapezoidal waveform Adp1 and the trapezoidal waveform Adp2 included in the drive signal COMA are switched, and the change signal CH that defines the timing at which the trapezoidal waveform Bdp1 and the trapezoidal waveform Bdp2 included in the drive signal COMB are switched, may be different signals.

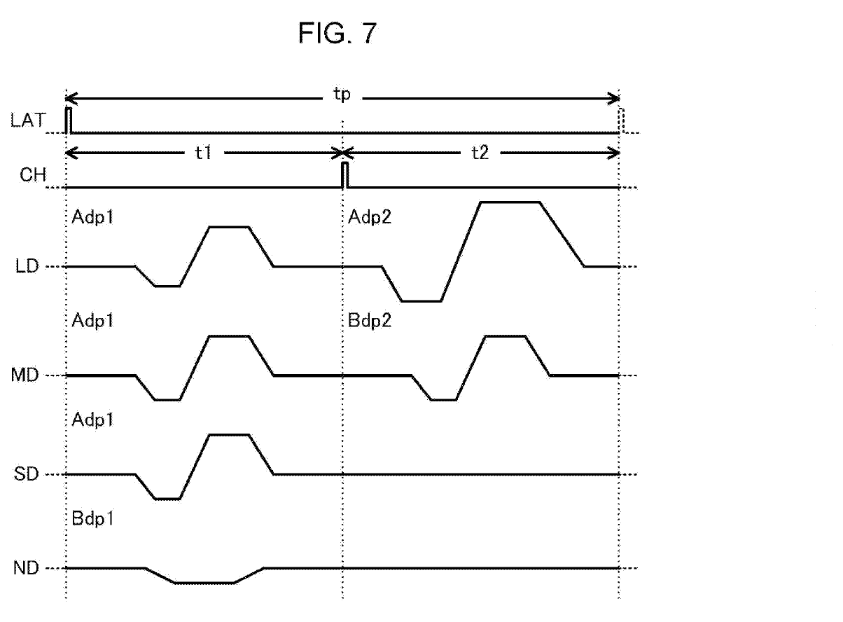

FIG. 7 is a diagram showing an example of the signal waveform of the drive voltage VOUT when the size of the dots formed at the medium P is any of a large dot LD, a medium dot MD, a small dot SD, and non-recording ND.

As shown in FIG. 7, the drive voltage VOUT when the large dot LD is formed at the medium P is a signal waveform in which the trapezoidal waveform Adp1 arranged in the period t1 in the cycle tp and the trapezoidal waveform Adp2 arranged in the period t2 in the cycle tp are made continuous. When the drive voltage VOUT is supplied to the piezoelectric element 60 included in the discharge section 600, a small amount of ink and a medium amount of ink are discharged from the corresponding discharge section 600. Therefore, each ink lands on the medium P and coalesces to form the large dot LD at the medium P in the cycle tp.

The drive voltage VOUT when the medium dot MD is formed at the medium P is a signal waveform in which the trapezoidal waveform Adp1 arranged in the period t1 in the cycle tp and the trapezoidal waveform Bdp2 arranged in the period t2 in the cycle tp are made continuous. When the drive voltage VOUT is supplied to the piezoelectric element 60 included in the discharge section 600, a small amount of ink is discharged twice from the corresponding discharge section 600. Therefore, each ink lands on the medium P and coalesces to form the medium dot MD at the medium P in the cycle tp.

The drive voltage VOUT when the small dot SD is formed at the medium P is a signal waveform in which the trapezoidal waveform Adp1 arranged in the period t1 in the cycle tp and a constant signal waveform arranged in the period t2 in the cycle tp at the voltage Vc are made continuous. When the drive voltage VOUT is supplied to the piezoelectric element 60 included in the discharge section 600, a small amount of ink is discharged once from the corresponding discharge section 600. Therefore, the ink lands on the medium P to form the small dot SD at the medium P in the cycle tp.

The drive voltage VOUT that corresponds to the non-recording ND that does not form dots at the medium P is a signal waveform in which the trapezoidal waveform Bdp1 arranged in the period t1 in the cycle tp and a constant signal waveform arranged in the period t2 in the cycle tp at the voltage Vc are made continuous. When the drive voltage VOUT is supplied to the piezoelectric element 60 included in the discharge section 600, the ink in the vicinity of the nozzle opening portion of the corresponding discharge section 600 micro-vibrates only, and no ink is discharged from the discharge section 600. Therefore, dots are not formed at the medium P in the cycle tp.

Here, in the constant signal waveform at the voltage Vc in the drive voltage VOUT, when none of the trapezoidal waveforms Adp1, Adp2, Bdp1, and Bdp2 is selected as the drive voltage VOUT, the voltage Vc immediately before the trapezoidal waveforms Adp1, Adp2, Bdp1, and Bdp2 corresponds to a voltage value held by the capacitive component of the piezoelectric element 60 included in the discharge section 600. In other words, when none of the trapezoidal waveforms Adp1, Adp2, Bdp1, and Bdp2 is selected as the drive voltage VOUT, the voltage Vc supplied immediately before is supplied to the piezoelectric element 60 included in the discharge section 600, as the drive voltage VOUT.

Here, the drive signal selection circuit 200, by selecting or not selecting the trapezoidal waveforms Adp1 and Adp2 included in the drive signal COMA and the trapezoidal waveforms Bdp1 and Bdp2 included in the drive signal COMB, generates drive voltages VOUT individually corresponding to a plurality of discharge sections 600 as shown in FIG. 7, and outputs the drive voltages VOUT to the piezoelectric elements 60 included in the corresponding discharge sections 600.

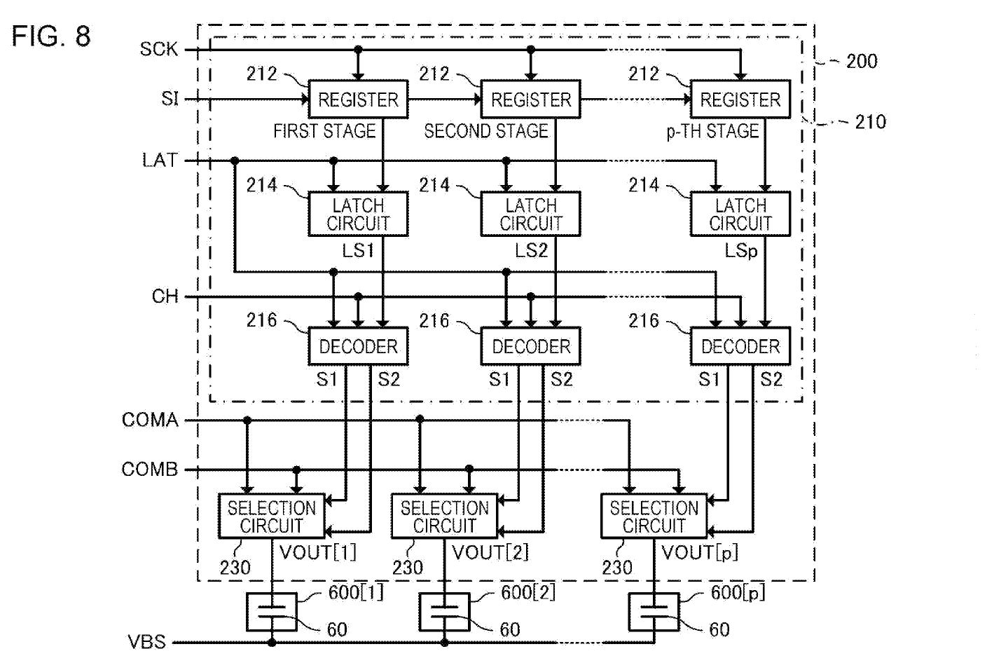

FIG. 8 is a diagram showing a functional configuration of the drive signal selection circuit 200. As shown in FIG. 8, the drive signal selection circuit 200 includes a selection control circuit 210 and a plurality of selection circuits 230. In addition, FIG. 8 also shows the discharge sections 600[1] to 600[p] to which the drive voltages VOUT[1] to VOUT[p] output from the drive signal selection circuit 200 are supplied.

The print data signal SI, the clock signal SCK, the latch signal LAT, and the change signal CH are input to the selection control circuit 210. A set of a register 212, a latch circuit 214, and a decoder 216 is provided corresponding to each of the discharge sections 600[1] to 600[p] in the selection control circuit 210. That is, the selection control circuit 210 includes at least a set of the registers 212, the latch circuits 214, and the decoders 216 in the same number as the discharge sections 600[1] to 600[p].

The print data signal SI is a signal synchronized with the clock signal SCK, and is a total2p-bit signal including, in series, 2-bit print data [SIH, SIL] for selecting one of the large dot LD, the medium dot MD, the small dot SD, and the non-recording ND with respect to each of the discharge sections 600[1] to 600[p]. The print data signal SI is held in the register 212 for each print data [SIH, SIL] included in the print data signal SI, corresponding to the discharge sections 600[1] to 600[p].

Specifically, in the selection control circuit 210, the registers 212 are vertically coupled to each other to constitute a p-step shift register. Then, the print data [SIH, SIL] serially input as the print data signal SI is sequentially transferred to the register 212 in the subsequent step according to the clock signal SCK. Then, when the supply of the clock signal SCK is stopped, the print data [SIH, SIL] corresponding to each of the discharge sections 600[1] to 600[p] is held in the registers 212 corresponding to each of the discharge sections 600[1] to 600[p]. In the following description, in order to distinguish the p registers 212 that constitute the shift register, the registers 212 may be referred to as a first stage, a second stage, ..., and a p-th stage from upstream to downstream where the print data signal SI propagates.

Each of the p latch circuits 214 is provided corresponding to the p registers 212. Each of the latch circuits 214 latches, at a rise of the latch signal LAT, the print data [SIH, SIL] held in each of the p registers 212 all at once, and outputs the print data [SIH, SIL] to the corresponding decoder 216.

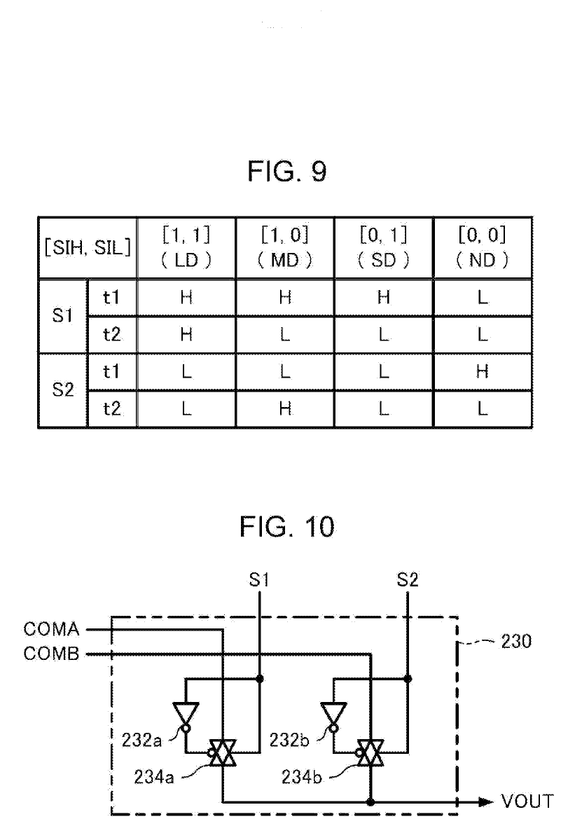

FIG. 9 is a table showing an example of decoding contents in the decoder 216. The decoder 216 generates and outputs selection signals S1 and S2 by decoding the print data [SIH, SIL] latched by the latch circuit 214 with the contents shown in FIG. 9. For example, when the input print data [SIH, SIL] is [1, 0], the decoder 216 outputs logic levels of the selection signal S1 to the selection circuit 230 as the H and L levels in the periods t1 and t2, and outputs logic levels of the selection signal S2 to the selection circuit 230 as the L and H levels in the periods t1 and t2.

The selection circuit 230 is provided corresponding to each of the p discharge sections 600. That is, the drive signal selection circuit 200 has p selection circuits 230 that are at least p discharge sections 600 in the same number. FIG. 10 is a diagram showing a configuration of the selection circuit 230 that corresponds to one discharge section 600. As shown in FIG. 10, the selection circuit 230 has inverters 232a and 232b, which are NOT circuits, and transfer gates 234a and 234b.

While the selection signal S1 is input to a positive control terminal which is not marked with a circle at the transfer gate 234a, the selection signal S1 is logically inverted by the inverter 232a and is input to a negative control terminal which is marked with a circle at the transfer gate 234a. Further, the drive signal COMA is supplied to an input terminal of the transfer gate 234a. While the selection signal S2 is input to the positive control terminal which is not marked with a circle at the transfer gate 234b, the selection signal S2 is logically inverted by the inverter 232b and is input to the negative control terminal which is marked with a circle at the transfer gate 234b. Further, the drive signal COMB is supplied to an input terminal of the transfer gate 234b. Then, an output terminal of the transfer gate 234a and an output terminal of the transfer gate 234b are commonly coupled. A signal at a coupled terminal to which the output terminal of the transfer gate 234a and the output terminal of the transfer gate 234b are commonly coupled is output as the drive voltage VOUT.

Specifically, the input terminal and the output terminal of the transfer gate 234a are made conductive when the selection signal S1 is at the H level, and the input terminal and the output terminal of the transfer gate 234a are made non-conductive when the selection signal S1 is at the L level. In addition, the input terminal and the output terminal of the transfer gate 234b are made conductive when the selection signal S2 is at the H level, and the input terminal and the output terminal of the transfer gate 234b are made non-conductive when the selection signal S2 is at the L level. That is, the selection circuit 230 switches a conduction state between the input terminals and the output terminals of the transfer gates 234a and 234b based on the selection signals S1 and S2, to select or not select the signal waveforms of the drive signals COMA and COMB supplied to the input terminals of the transfer gates 234a and 234b, and output the drive voltage VOUT to the coupled terminal at which the output terminal of the transfer gate 234a and the output terminal of the transfer gate 234b are commonly coupled.

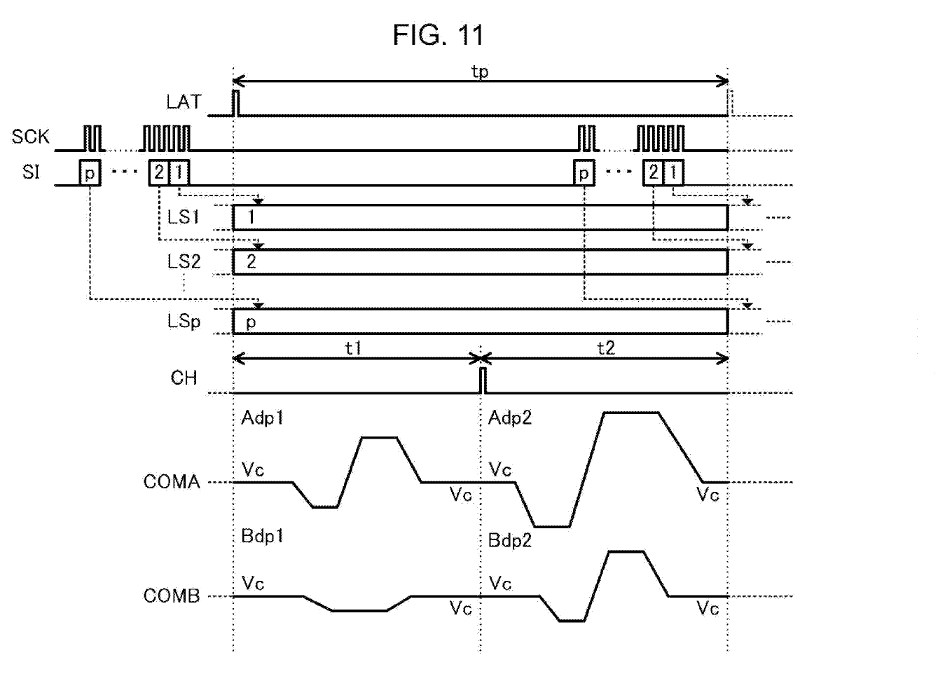

The operation of the drive signal selection circuit 200 will be described with reference to FIG. 11. FIG. 11 is a diagram illustrating the operation of the drive signal selection circuit 200. The print data [SIH, SIL] included in the print data signal SI is serially input in synchronization with the clock signal SCK. Then, the print data [SIH, SIL] is sequentially transferred by the register 212 that constitutes the shift register corresponding to the p discharge sections 600 in synchronization with the clock signal SCK. After that, when the supply of the clock signal SCK is stopped, the print data [SIH, SIL] is held in each of the registers 212 corresponding to each of the p discharge sections 600. The print data [SIH, SIL] included in the print data signal SI is input in the order corresponding to the discharge sections 600 at the p-th stage, ..., a second stage, and a first stage of the register 212 that constitutes the shift register.

Then, when the latch signal LAT rises, each of the latch circuits 214 latches the print data [SIH, SIL] held in the register 212 all at once. In FIG. 11, LS1, LS2, ..., and LSp indicate the print data [SIH, SIL] latched by the latch circuits 214 that correspond to the registers 212 at the first stage, second stage, ..., and p-th stage.

The decoder 216 outputs the logic levels of the selection signals S1 and S2 in each of the periods t1 and t2 with the contents shown in FIG. 9, according to the size of the dot defined by the latched print data [SIH, SIL].

Specifically, when the input print data [SIH, SIL] is [1, 1], the decoder 216 sets a logic level of the selection signal S1 to the H and H levels in the periods t1 and t2, and sets a logic level of the selection signal S2 to the L and L levels in the periods t1 and t2. In this case, the selection circuit 230 selects the trapezoidal waveform Adp1 in the period t1 and selects the trapezoidal waveform Adp2 in the period t2. As a result, at an output terminal of the selection circuit 230, a drive voltage VOUT that corresponds to the large dot LD shown in FIG. 7 is generated.

Further, when the input print data [SIH, SIL] is [1, 0], the decoder 216 sets a logic level of the selection signal S1 to the H and L levels in the periods t1 and t2, and sets a logic level of the selection signal S2 to the L and H levels in the periods t1 and t2. In this case, the selection circuit 230 selects the trapezoidal waveform Adp1 in the period t1 and selects the trapezoidal waveform Bdp2 in the period t2. As a result, at the output terminal of the selection circuit 230, a drive voltage VOUT that corresponds to the medium dot MD shown in FIG. 7 is generated.

Further, when the input print data [SIH, SIL] is [0, 1], the decoder 216 sets a logic level of the selection signal S1 to the H and L levels in the periods t1 and t2, and sets a logic level of the selection signal S2 to the L and L levels in the periods t1 and t2. In this case, the selection circuit 230 selects the trapezoidal waveform Adp1 in the period t1 and selects none of the trapezoidal waveforms Adp2 and Bdp2 in the period t2. As a result, at the output terminal of the selection circuit 230, a drive voltage VOUT that corresponds to the small dot SD shown in FIG. 7 is generated.

Further, when the input print data [SIH, SIL] is [0, 0], the decoder 216 sets a logic level of the selection signal S1 to the L and L levels in the periods t1 and t2, and sets a logic level of the selection signal S2 to the H and L levels in the periods t1 and t2. In this case, the selection circuit 230 selects the trapezoidal waveform Bdp1 in the period t1 and selects none of the trapezoidal waveforms Adp2 and Bdp2 in the period t2. As a result, at the output terminal of the selection circuit 230, a drive voltage VOUT that corresponds to the non-recording ND shown in FIG. 7 is generated.

As described above, the drive signal selection circuit 200 generates and outputs the drive voltages VOUT[1] to VOUT[p] by selecting the signal waveforms of the drive signal COMA and the drive signal COMB, based on the print data signal SI, the clock signal SCK, the latch signal LAT, and the change signal CH.

### 6. Fireproof Enclosure

In fourth edition of IEC 62368-1, circuits are classified into three types of PS1, PS2, and PS3, depending on the power supply capacity. PS1 is a circuit in which power satisfies 15 W or less after 3 seconds in any case. PS2 is a circuit in which the power exceeds PS1 and satisfies 100 W or less after 5 seconds in any case. PS3 is a circuit in which the power exceeds 100 W. The electronic components classified into PS1 or PS2 do not need to be covered with a fireproof enclosure, but the electronic components classified into PS3 need to be covered with the fireproof enclosure.

Examples of the electronic component with the power of 100 W or more include a CPU, a chip capacitor, an electric field capacitor, and the like, and examples of the electronic component with the power of less than 100 W include a fuse, a switch, an LED, and the like. LED is an abbreviation for a light emitting diode. The electronic component with the power of less than 100 W may be covered with the fireproof enclosure together with the electronic component with the power of 100 W or more, but when the switch or the LED is covered with the fireproof enclosure, it becomes difficult to access or the light is not visible. Therefore, the switch or the LED is not suitable to be covered with the fireproof enclosure.

In the printing apparatus 1, for example, some electronic components mounted on the control circuit substrate 10, some electronic components mounted on the power supply circuit substrate 11, and some electronic components mounted on the drive circuit substrate 12 may have the power exceeding 100 W, and need to be covered with a fireproof enclosure.

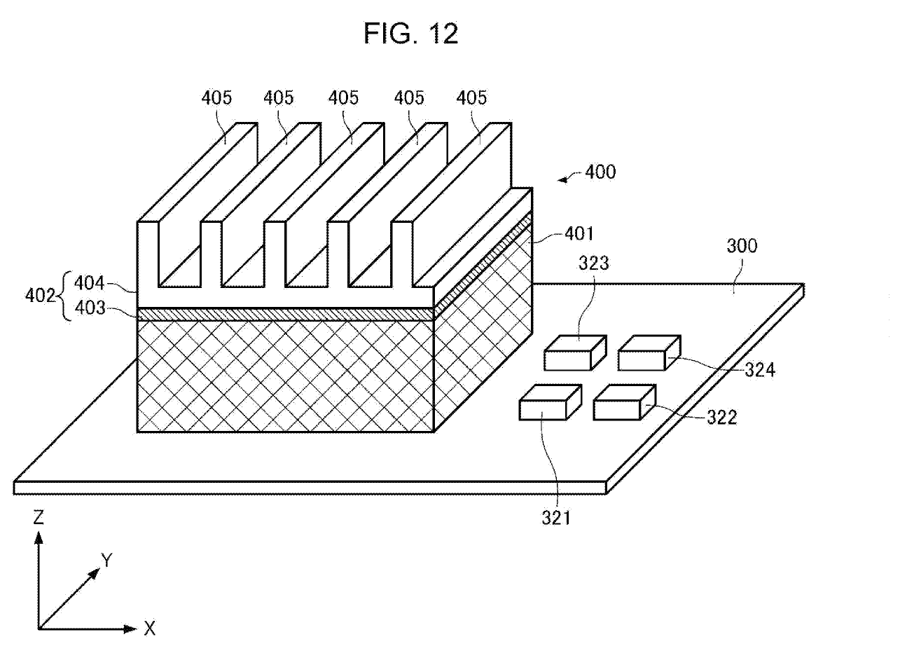

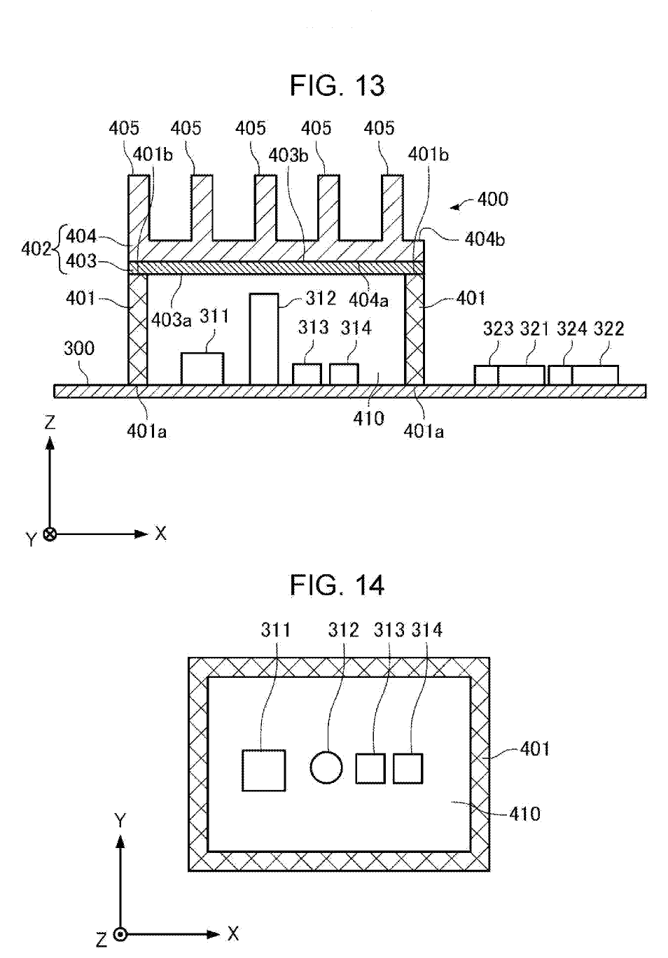

FIG. 12 is a perspective view of a substrate provided with the fireproof enclosure. FIG. 13 is a side view of the substrate in a state where the fireproof enclosure shown in FIG. 12 is cut. In FIGS. 12 and 13, an X axis, a Y axis, and a Z axis, which are orthogonal to each other, are also shown for convenience of showing the correspondence between directions of both figures. FIG. 13 is a view seen from a starting point side of an arrow indicating the direction of the Y axis.

As shown in FIGS. 12 and 13, a substrate 300 is, for example, a printed circuit board, and includes a plurality of electronic components including electronic components 311, 312, 313, 314, 321, 322, 323, and 324. For example, the substrate 300 is the drive circuit substrate 12, the control circuit substrate 10, or the power supply circuit substrate 11. For example, the electronic component 311 is an electronic component with the power to be supplied of 100 W or more, and is covered with a fireproof enclosure 400 together with the electronic components 312, 313, and 314. For example, the electronic component 311 may be a capacitor, a transistor, or a processor. Each of the electronic components 312, 313, and 314 may be an electronic component in which supplied power is 100 W or more, or may be an electronic component in which supplied power is less than 100 W. In addition, the electronic components 321, 322, 323, and 324 are electronic components in which supplied power is less than 100 W, and are not covered with the fireproof enclosure 400. For example, each of the electronic components 321, 322, 323, and 324 may be a fuse, a switch, or an LED.

The fireproof enclosure 400 includes a wall portion 401 and a top plate portion 402. FIG. 14 is a view of the wall portion 401 viewed from a distal end side of an arrow indicating a direction of the Z axis. As shown in FIGS. 13 and 14, in order to suppress the spread of the fire, the wall portion 401 is a flame-retardant resin member of V-1 grade or higher of UL94, which is a standard for evaluating combustibility of materials, and surrounds four sides of the electronic components 311, 312, 313, and 314. In UL94, three grades of V-0, V-1, and V-2 are defined as grades of vertical burning tests, and the material of V-0 grade has the highest flame retardancy, and the material of V-1 grade has the next highest flame retardancy. For example, the material of V-0 grade has a combustion time of 10 seconds or less, and the material of V-1 grade or V-2 grade has a combustion time of 30 seconds or less. In addition, in the material of V-0 grade or V-1 grade, the cotton wadding does not ignite due to the molten material dropped by combustion, and in the material of V-2 grade, the cotton wadding ignites due to the molten material dropped by combustion. A flame-retardant resin of V-1 grade or higher is a flame-retardant resin of V-0 grade or V-1 grade, and examples thereof include a polyether ether ketone (PEEK), a polyphenylene sulfide (PPS), a polytetrafluoroethylene (PTFE), a polyvinylidene fluoride (PVDF), a polyether imide (PEI), a polyamide imide (PAI), a polyphenylsulfone (PPSU), a polyimide (PI), a modified polyphenylene ether (PPE), and the like.

As shown in FIG. 13, a bottom surface 401a of the wall portion 401 is in contact with the substrate 300, and an upper surface 401b of the wall portion 401 on an opposite side of the bottom surface 401a is in contact with the top plate portion 402. It should be noted that the bottom surface 401a of the wall portion 401 being in contact with the substrate 300 includes not only a state in which both are in direct contact with each other but also a state in which an adhesive or the like is provided therebetween. Similarly, the upper surface 401b of the wall portion 401 being in contact with the top plate portion 402 includes not only a state in which both are in direct contact with each other but also a state in which an adhesive or the like is provided therebetween. For example, the wall portion 401 is fixed to the substrate 300 with an adhesive or with a bolt and a nut.

Since the wall portion 401, which is the flame-retardant resin member, has a high insulating property, a contact surface between the wall portion 401 and the substrate 300 is insulated, and the risk of leakage or short circuit is reduced. It should be noted that an insulating member may be attached to the contact surface between the wall portion 401 and the substrate 300.

As shown in FIGS. 13 and 14, the wall portion 401 has a rectangular parallelepiped-shaped cavity extending from the bottom surface 401a to the upper surface 401b, and the electronic components 311, 312, 313, and 314 are accommodated in the cavity.

As shown in FIG. 13, the top plate portion 402 is constituted by a metal flat plate 403 and a heat sink 404. A lower surface 403a of the metal flat plate 403 is in contact with the upper surface 401b of the wall portion 401, and an upper surface 403b of the metal flat plate 403 is in contact with the bottom surface 404a of the heat sink 404. For example, the metal flat plate 403 of the top plate portion 402 is fixed to the wall portion 401 with an adhesive, a screw, or by fitting. The wall portion 401 and the metal flat plate 403 of the top plate portion 402 may be fixed with a screw by using a screw thread insert (helisert), or may be fixed with a bolt and a nut.

In addition, for example, the heat sink 404 is fixed to the metal flat plate 403 with an adhesive, a screw, or by fitting. In fixation by fitting, either the heat sink 404 or the metal flat plate 403 may have a protrusion portion. In addition, the metal flat plate 403 and the heat sink 404 may be fixed with a screw by using the screw thread insert, or may be fixed with a bolt and a nut.

The heat sink 404 is a heat dissipation member, and in order to enhance heat dissipation, a plurality of prismatic projection portions 405 are provided on an upper surface 404b of the heat sink 404. For weight reduction, the metal flat plate 403 and the heat sink 404 are made of aluminum.

When the wall portion 401 and the metal flat plate 403 are fixed with an adhesive, it is preferable that the adhesive is an adhesive having high thermal conductivity in order to enhance the heat dissipation. Similarly, when the metal flat plate 403 and the heat sink 404 are fixed with an adhesive, it is preferable that the adhesive is an adhesive having high thermal conductivity in order to enhance the heat dissipation.

With the structure of the fireproof enclosure 400, a cavity portion of the wall portion 401 forms a sealed space 410, and the electronic components 311, 312, 313, and 314 mounted on the substrate 300 are disposed in the sealed space 410. That is, the electronic components 311, 312, 313, and 314 are covered with the fireproof enclosure 400 in a state of being surrounded on four sides by the wall portion 401, which is a flame-retardant resin member of V-1 grade or higher, and the metal flat plate 403, which is flame-retardant, so that even when any of the electronic components 311, 312, 313, and 314 ignites, the spread of fire is prevented. The cavity portion of the wall portion 401 may not form a completely sealed space, and a slight gap allowed in fourth edition of IEC 62368-1, may be provided.

Further, the heat generated by the electronic components 311, 312, 313, and 314 is conducted to the heat sink 404 via the metal flat plate 403 and is efficiently released from the heat sink 404 provided with the plurality of projection portions 405.

The metal flat plate 403 may not be provided, and the heat sink 404 may constitute the top plate portion 402 alone. In this case, the bottom surface 404a of the heat sink 404 is in contact with the upper surface 401b of the wall portion 401. For example, the heat sink 404, which is the top plate portion 402, is fixed to the wall portion 401 with an adhesive, a screw, or by fitting. Alternatively, the wall portion 401 and the heat sink 404, which is the top plate portion 402, may be fixed with a screw by using a screw thread insert.

As described above, regardless of the presence or absence of the metal flat plate 403, the top plate portion 402 is made of aluminum, and unevenness for heat dissipation is arranged corresponding to the plurality of projection portions 405. When the metal flat plate 403 is present, the top plate portion 402 has a surface 403a in contact with the wall portion 401 and a surface 404b on an opposite side of the surface 403a, and a plurality of prismatic projection portions 405 are provided on the surface 404b. In addition, when the metal flat plate 403 is not present, the top plate portion 402 has a surface 404a in contact with the wall portion 401 and a surface 404b on an opposite side of the surface 404a, and a plurality of prismatic projection portions 405 are provided on the surface 404b.

A transport mechanism 4 is an example of a "transport section". In addition, the electronic component 311 is an example of a "first element", and the electronic component 321 is an example of a "second element". Further, the bottom surface 401a of the wall portion 401 is an example of a "first surface", and the upper surface 401b of the wall portion 401 is an example of a "second surface". Further, the surface 403a or the surface 404a of the top plate portion 402 in contact with the wall portion 401 is an example of a "third surface", and the surface 404b of the top plate portion 402 is an example of a "fourth surface".

### 7. Action and Effect

As described above, in the printing apparatus 1 of the present embodiment, since the electronic component 311 that is relatively likely to ignite because the supplied power is 100 W or more is covered with the fireproof enclosure 400 configured with the wall portion 401 of the flame-retardant resin member of V-1 grade or higher and the top plate portion 402 that is the flame-retardant aluminum member, the risk of fire spread due to ignition of the electronic component 311 is reduced. In addition, the wall portion 401 of the flame-retardant resin member having high insulation is provided on the contact surface between the fireproof enclosure 400 and the substrate 300, so that the risk of leakage or short circuit is reduced.

Further, according to the printing apparatus 1 of the present embodiment, since the top plate portion 402 is made of aluminum instead of a flame-retardant resin member and the top plate portion 402 is provided with unevenness for heat dissipation, the heat dissipation in the fireproof enclosure 400 can be improved. In addition, according to the printing apparatus 1 of the present embodiment, since the wall portion 401 is made of a flame-retardant resin member lighter than metal, the weight reduction of the fireproof enclosure 400 is also achieved. Therefore, according to the printing apparatus 1 of the present embodiment, both enhancement of heat dissipation of the fireproof enclosure 400 and weight reduction are achieved.

Further, according to the printing apparatus 1 of the present embodiment, a part of the ink discharged from the print heads 22-1 to 22-n becomes mist before landing on the medium P and floats in the air, and liquid landing on the medium P is also re-floated and becomes mist before being absorbed into the medium P and solidified. However, since the electronic component 311, which is relatively likely to ignite, is covered with the fireproof enclosure 400, a risk of leakage or short circuit due to ink mist leading to ignition of the electronic component 311 is reduced.

In particular, in the relatively small printing apparatus 1 in which the medium P has a size equal to or smaller than the A3 short side width, an inside of the housing tends to be at a high temperature, and the ink mist tends to adhere to the substrate 300. However, the risk that the electronic component 311 ignites is reduced by the fireproof enclosure 400.

The present disclosure is not limited to the present embodiment, and various modifications may be made within the scope of the gist of the present disclosure.

The present disclosure includes substantially the same configurations, for example, configurations having the same functions, methods, and results, or configurations having the same objects and effects, as the configurations described in the present embodiment. In addition, the present disclosure includes configurations in which non-essential parts of the configuration described in the present embodiment are replaced. In addition, the present disclosure includes configurations that achieve the same operational effects or configurations that can achieve the same objects as those of the configurations described in the present embodiment. In addition, the present disclosure includes configurations in which a known technology is added to the configurations described in the present embodiment.

The embodiment and the modification example described above are merely examples, and the present disclosure is not limited thereto. For example, each embodiment and each modification example can be combined as appropriate.

The following contents are derived from the embodiment and modification example described above.

According to one aspect, there is provided a printing apparatus including a transport section configured to transport a medium, a discharge section configured to discharge a liquid to the medium, and a substrate including a first element that is supplied with power of 100 W or more and a second element that is supplied with power of less than 100 W, in which the first element is covered with a fireproof enclosure, the second element is not covered with the fireproof enclosure, the fireproof enclosure includes a wall portion and a top plate portion, the wall portion is a flame-retardant resin member having a V-1 grade or higher and surrounds four sides of the first element, a first surface of the wall portion is in contact with the substrate, a second surface opposite to the first surface of the wall portion is in contact with the top plate portion, and the top plate portion is made of aluminum and unevenness for heat dissipation is arranged on the top plate portion.

According to this printing apparatus, since the first element that is relatively likely to ignite because the supplied power is 100 W or more is covered with the fireproof enclosure made of a flame-retardant resin member of V-1 grade or higher and a flame-retardant aluminum, the risk of fire spread due to ignition of the first element is reduced. In addition, the wall portion of the flame-retardant resin member having high insulation is provided on the contact surface between the fireproof enclosure and the substrate, so that the risk of leakage or short circuit is reduced.

Further, according to the printing apparatus, since the top plate portion is made of aluminum instead of a flame-retardant resin member and the top plate portion is provided with unevenness for heat dissipation, the heat dissipation in the fireproof enclosure can be improved. In addition, according to the printing apparatus, since the wall portion is made of a flame-retardant resin member lighter than metal, the weight reduction of the fireproof enclosure is also achieved. Therefore, according to the printing apparatus, both enhancement of heat dissipation of the fireproof enclosure and weight reduction are achieved.

Further, according to the printing apparatus, a part of the liquid discharged from the discharge section becomes mist before landing and floats in the air, and the liquid landing on the medium is also re-floated and becomes mist before being absorbed into the medium and solidified. However, since the first element which is relatively likely to ignite is covered with the fireproof enclosure, a risk of leakage or short circuit due to mist leading to ignition of the first element is reduced.

In one aspect of the printing apparatus, the wall portion may be fixed to the substrate with an adhesive or with a bolt and a nut.

In one aspect of the printing apparatus, the top plate portion may be fixed to the wall portion with an adhesive, a screw, or by fitting.

In one aspect of the printing apparatus, the wall portion and the top plate portion may be fixed with screws by using a screw thread insert.

In one aspect of the printing apparatus, the wall portion may have a rectangular parallelepiped-shaped cavity extending from the first surface to the second surface, and the first element may be accommodated in the cavity.

In one aspect of the printing apparatus, the first element may be a capacitor, a transistor, or a processor.

In one aspect of the printing apparatus, the second element may be a fuse, a switch, or an LED.

In one aspect of the printing apparatus, the substrate may be a printed circuit board.

In one aspect of the printing apparatus, the discharge section may include a piezoelectric element.

In one aspect of the printing apparatus, the substrate may be a drive circuit substrate on which a drive circuit that generates a drive signal for causing the discharge section to discharge the liquid is mounted, a control circuit substrate on which a control circuit that controls the discharge of the liquid from the discharge section is mounted, or a power supply circuit substrate on which a power supply circuit is mounted.

According to the printing apparatus, a risk that the drive circuit substrate, the control circuit substrate, or the power supply circuit substrate on which the first element supplied with power of 100 W or more is mounted is ignited is reduced.

In one aspect of the printing apparatus, the drive circuit may include a class D amplifier which is an amplifier circuit.

In one aspect of the printing apparatus, the drive signal output from the drive circuit may be an analog signal.

In one aspect of the printing apparatus, the control circuit may output a base drive signal, which is a digital signal that is a base of the drive signal output from the drive circuit.

In one aspect of the printing apparatus, the power supply circuit may include a voltage conversion circuit and a smoothing circuit.

In one aspect of the printing apparatus, the voltage conversion circuit may include a transformer that transforms an AC voltage of a commercial power supply.

In one aspect of the printing apparatus, the smoothing circuit may include a rectifying circuit and a capacitor.

In one aspect of the printing apparatus, the rectifying circuit may be a diode bridge circuit and rectifies an AC voltage converted by the voltage conversion circuit.

In one aspect of the printing apparatus, the medium may have a size equal to or smaller than an A3 short side width.

According to this printing apparatus, since it is relatively small, an inside of the housing tends to be at a high temperature, and mist also tends to adhere to the substrate, but a risk that the first element ignites is reduced by the fireproof enclosure.

In one aspect of the printing apparatus, the top plate portion may have a third surface that is in contact with the wall portion and a fourth surface opposite to the third surface, and a plurality of prismatic projection portions may be provided on the fourth surface.

According to the printing apparatus, since the plurality of prismatic projection portions are provided in the top plate portion, the heat dissipation in the fireproof enclosure can be improved.

What is claimed is:

1. A printing apparatus comprising:
a transport section configured to transport a medium;
a discharge section configured to discharge a liquid to the medium; and
a substrate including a first element that is supplied with power of 100 W or more and a second element that is supplied with power of less than 100 W, wherein
the first element is covered with a fireproof enclosure,
the second element is not covered with the fireproof enclosure,
the fireproof enclosure includes a wall portion and a top plate portion,
the wall portion is a flame-retardant resin member having a V-1 grade or higher and surrounds four sides of the first element,
a first surface of the wall portion is in contact with the substrate,
a second surface opposite to the first surface of the wall portion is in contact with the top plate portion, and
the top plate portion is made of aluminum and unevenness for heat dissipation is arranged on the top plate portion.

2. The printing apparatus according to claim 1, wherein
the wall portion is fixed to the substrate with an adhesive or with a bolt and a nut.

3. The printing apparatus according to claim 1, wherein
the top plate portion is fixed to the wall portion with an adhesive, a screw, or by fitting.

4. The printing apparatus according to claim 1, wherein
the wall portion and the top plate portion are fixed with a screw by using a screw thread insert.

5. The printing apparatus according to claim 1, wherein
the wall portion has a rectangular parallelepiped-shaped cavity extending from the first surface to the second surface, and
the first element is accommodated in the cavity.

6. The printing apparatus according to claim 1, wherein
the first element is a capacitor, a transistor, or a processor.

7. The printing apparatus according to claim 1, wherein
the second element is a fuse, a switch, or an LED.

8. The printing apparatus according to claim 1, wherein
the substrate is a printed circuit board.

9. The printing apparatus according to claim 1, wherein
the discharge section includes a piezoelectric element.

10. The printing apparatus according to claim 1, wherein
the substrate is a drive circuit substrate on which a drive circuit that generates a drive signal for causing the discharge section to discharge the liquid is mounted, a control circuit substrate on which a control circuit that controls the discharge of the liquid from the discharge section is mounted, or a power supply circuit substrate on which a power supply circuit is mounted.

11. The printing apparatus according to claim 10, wherein
the drive circuit includes a class D amplifier which is an amplifier circuit.

12. The printing apparatus according to claim 10, wherein
the drive signal output from the drive circuit is an analog signal.

13. The printing apparatus according to claim 10, wherein
the control circuit outputs a base drive signal, which is a digital signal that is a base of the drive signal output from the drive circuit.

14. The printing apparatus according to claim 10, wherein
the power supply circuit includes a voltage conversion circuit and a smoothing circuit.

15. The printing apparatus according to claim 14, wherein
the voltage conversion circuit includes a transformer that transforms an AC voltage of a commercial power supply.

16. The printing apparatus according to claim 14, wherein
the smoothing circuit includes a rectifying circuit and a capacitor.

17. The printing apparatus according to claim 16, wherein
the rectifying circuit is a diode bridge circuit and rectifies an AC voltage converted by the voltage conversion circuit.

18. The printing apparatus according to claim 1, wherein
the medium has a size equal to or smaller than an A3 short side width.

19. The printing apparatus according to claim 1, wherein
the top plate portion has a third surface that is in contact with the wall portion and a fourth surface opposite to the third surface, and
a plurality of prismatic projection portions are provided on the fourth surface.
